(19) United States
(12) Patent Application Publication
(10) Pub. No.: US 2004/0246909 A1
(43) Pub. Date: Dec. 9, 2004

(54) Apparatus and method for transferring USB transaction over wireless personal area network

(75) Inventor: Cheol-hong Ahn, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/770,566

(22) Filed: Feb. 4, 2004

(30) Foreign Application Priority Data
Jun. 3, 2003 (KR) 10-2003-0035776

(51) Int. Cl. G06F 11/00; H04L 12/56

(52) U.S. Cl. 370/252; 370/466; 370/468; 370/328

(57) ABSTRACT

Disclosed herewith is an apparatus and method for transferring a Universal Serial Bus (USB) over a wireless Personal Area Network (PAN). The apparatus includes a USB device discovery module, a USB device list storage module, and an endpoint bandwidth allocation module. The USB device discovery module discovers a USB device from devices on the wireless PAN. The USB device list storage module stores information of the discovered device. The endpoint bandwidth allocation module is allocated an appropriate channel time according to a type of a transaction that can be found from the information of the discovered device.

### BACKGROUND OF THE INVENTION

1. Field of the Invention

The present invention relates generally to an apparatus and method for applying wired universal serial bus technology and applications to a wireless personal area network field, and more particularly to an apparatus and method that enables wireless communication between a universal serial bus host and a universal serial bus device by adding a new apparatus to a universal serial bus protocol stack. The present Application claims priority from Korean Application No. 10-2003-0035776 filed Jun. 3, 2003 and U.S. Provisional Application No. 60/490,902 filed Jul. 30, 2003, which are incorporated herein in full by reference.

2. Description of the Related Art

As the digital era spreads and develops, digital products are becoming more popular. For example, many digital products, such as Digital Versatile Disc (DVD) players, cable SetTop Boxes (STBs), Digital Video Cassette Recorders (DVCRs), Digital TeleVisions (DTVs), and Personal Computers (PCs), are being connected to a single network. In particular, many Universal Serial Bus (USB) devices are connected to a USB host in a wired manner. With the development of wireless technology, attempts have been made to connect these devices to each other in a wireless manner other but not in the wired manner.

Conventionally, as shown in FIG. 1, when a new USB device is connected to a port of a USB host, the USB host detects the connection of the new USB device using a root hub function included in the PHysical Layer (PHY) of USB, and automatically detects and loads a USB class driver corresponding to the new USB device. As a result, a USB application establishes a channel to communicate with a USB device function. At this time, in a lower layer, the following four transactions are performed. Through these transactions, the USB application can perform the function of the device by transferring commands to the USB device function.

A first transaction is a control transfer. This control transfer is bursty and non-periodic, and employs host software-initiated request/response communication. This method is used for command/status operations.

A second transaction is an isochronous transfer. This isochronous transfer is periodic, and performs continuous communication between a host and a device. This method is the method that is required for the case where data must be transferred at the approximately same speed as an original data flow (a video stream, for example). This isochronous transfer method is discriminated from an asynchronous transfer method suitable for processes that independently continue until a dependent process discontinues the other processes, and a synchronous transfer method in which a process must wait for the termination of the event of another process before the continuation thereof.

A third transaction is an interrupt transfer. This interrupt transfer uses a low frequency, and performs bounded-latency communication.

A fourth transaction is a bulk transfer. This bulk transfer is non-periodic. The bulk transfer is a data transfer method in which an entire bandwidth is used when the entire bandwidth is available, while data transfer is delayed until an entire bandwidth becomes available, when the entire bandwidth is unavailable.

### SUMMARY OF THE INVENTION

Accordingly, the present invention has been made keeping in mind the above problems occurring in the prior art, and an object of the present invention is to provide an apparatus and method for wirelessly transferring the transactions of existing wired USB.

Another object of the present invention is to provide a method that assigns an appropriate channel time according to a transaction method in the case where a USB host and a USB device wirelessly communicate with each other.

In order to accomplish the above object, the present invention provides an apparatus for transferring a USB over a wireless Personal Area Network (PAN), including a USB device discovery module for discovering a USB device from devices on the wireless PAN; a USB device list storage module for storing information of the discovered device; and an endpoint bandwidth allocation module for allocating an appropriate channel time according to a type of a transaction that can be found from the information of the discovered device

In order to accomplish the above object, the present invention provides a method of transferring a USB over a wireless PAN, including the steps of reading a device descriptor of an associated USB device; ascertaining a type of a transaction of an endpoint using the device descriptor; and determining a channel time according to results of the ascertainment and transferring data during the channel time. Further, the present invention includes a computer-readable recording medium for recording a computer program code for enabling a computer to provide the above method.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram of a wired USB protocol stack;

FIG. 2 is a diagram of a wireless USB protocol stack;

FIG. 3 is a diagram showing the architecture of a USB Frame Conversion Sublayer (FCSL) according to the present invention;

FIG. 4 is a diagram showing a wireless communication process between a USB host and a USB device;

FIG. 5 is a flowchart showing a process of discovering a USB device;

FIG. 6 is a flowchart showing a process performed on a layer higher than a USB FCSL;

FIG. 7 is a flowchart showing a step of allocating a channel time and transferring data;

FIG. 8 is a table showing USB device descriptors; and

FIG. 9 is a table showing USB endpoint descriptors.

### DESCRIPTION OF THE PREFERRED EMBODIMENTS

Reference now should be made to the drawings, in which the same reference numerals are used throughout the different drawings to designate the same or similar components.

Hereinafter, an embodiment of the present invention is described with reference to the accompanying drawings.

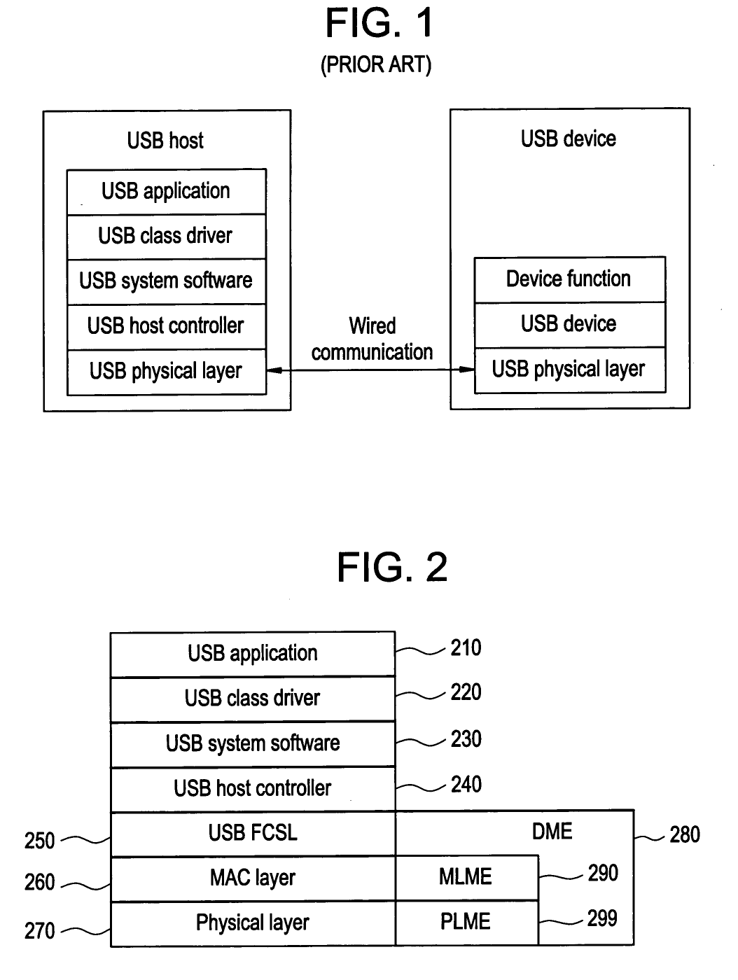

FIG. 2 is a diagram showing the protocol stack of a wireless USB host in accordance with the present invention. The present invention maintains the basic architecture of the protocol stack of the wired USB host shown in FIG. 1, but is different from the basic architecture of the protocol stack of the wired USB host in that a Media Access Control (MAC) layer for media access control is interposed between a USB host controller layer 240 and a physical layer 270 and a USB Frame Conversion Sub Layer (FCSL) 250 is disposed between the USB host controller layer 240 and the MAC layer 260. The present invention enables compatible communication between wireless devices by disposing the MAC layer 260 of a type used in a basic wireless Local Area Network (LAN) and a USB FCSL 250 proposed in the present invention, and allows the transactions of existing wired USB to be wirelessly transferred.

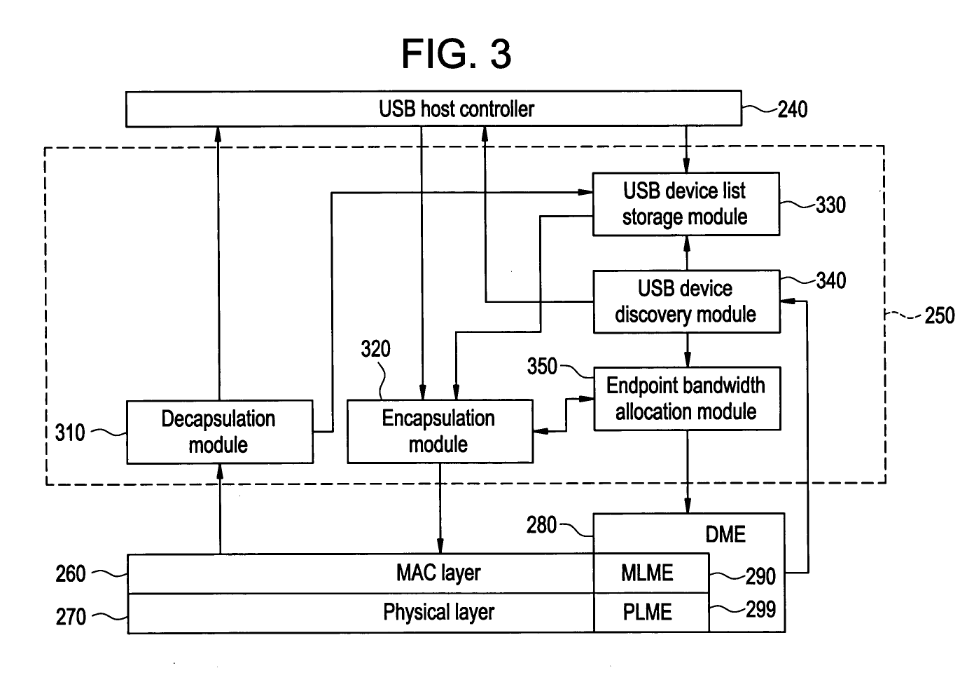

FIG. 3 is a diagram showing the architecture of the USB FCSL in accordance with the present invention. As illustrated in this drawing, the USB FCSL includes a USB device discovery module 340 for discovering a USB device from devices on a PAN, an encapsulation module 320 for encapsulating a USB packet into a MAC packet on a wireless PAN, an endpoint bandwidth allocation module 350 for requesting an appropriate channel time according to the type of a transaction, which can be found from the information of the discovered device, from a PicoNet Coordinator (PNC), and allocating the appropriate channel time, a decapsulation module 310 for decapsulating a received MAC packet into a USB packet, and a USB device list storage module 330 for storing the information of the discovered device.

The USB device discovery module 340 requests the information of an existing associated device or the device descriptor of a newly associated device, and registers a corresponding node with a USB device list if there is a response to the request. Thereafter, the USB device discovery module 340 notifies a higher USB host controller of the existence of a new USB device. This process is referred to as a discovery process. Meanwhile, information about the fact that a device is newly associated or dissociated is obtained through the MLME-DEV-ASSOCIATION of MAC subLayer Management Entity SAP (MLME SAP). In the case where the association occurs, the above-described discovery process is performed. In contrast, in the case where the dissociation occurs, the item of a corresponding device is removed from the USB device list and a higher layer is notified of the detachment of the device.

The encapsulation module 320 functions to encapsulate the packet of each transaction into a MAC packet. That is, the encapsulation module 320 encapsulates each of the transaction packets transferred from the USB host controller layer 240 into a MAC packet before performing a control transfer, isochronous transfer, an interrupt transfer and a bulk transfer, and transfers the encapsulated MAC packet.

In the isochronous transfer, the endpoint bandwidth allocation module 350 is allocated an isochronous channel time at a super-rate in the case of a high bandwidth isochronous transfer, and a general isochronous channel time in the case of a non-high bandwidth isochronous transfer. In the case of an interrupt transaction, an isochronous channel time is allocated at a sub-rate, and in the case of a control transaction, an isochronous channel time for multicast or broadcast is allocated. Further, in the case of a bulk transaction, an asynchronous channel time is allocated.

The decapsulation module 310 functions to decapsulate data received from the MAC SAP and transfer the decapsulated data to the higher USB host controller.

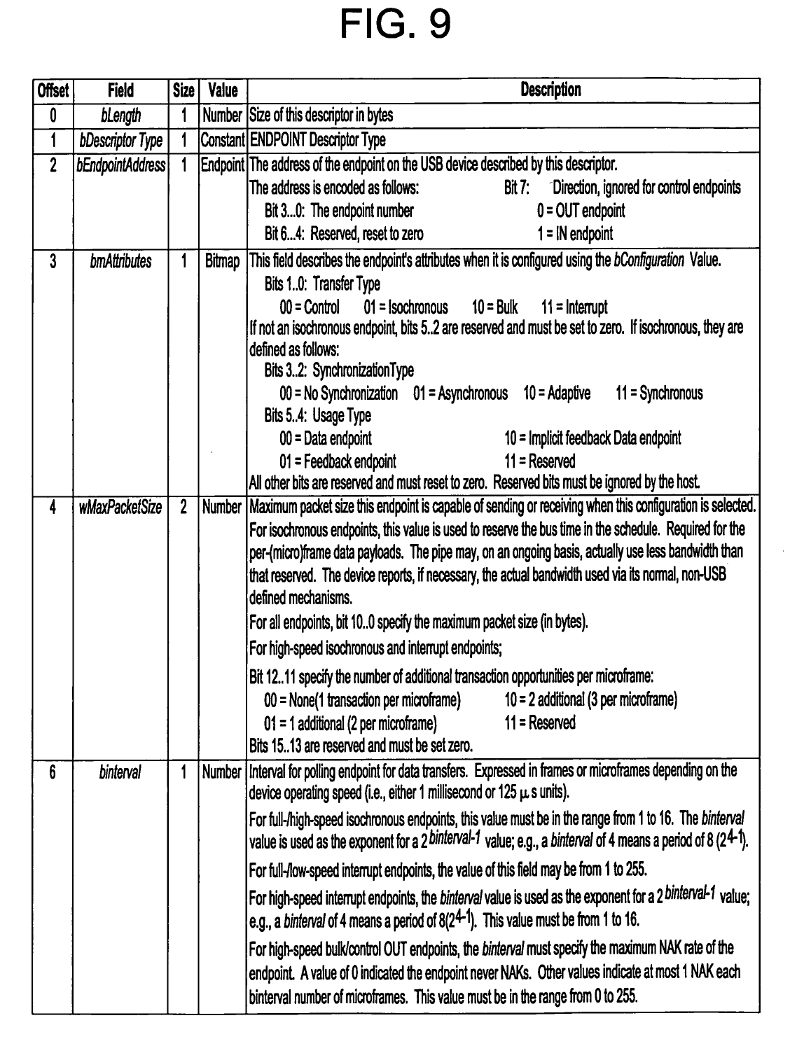

The device list storage module 330 stores information on a wireless USB device. This information includes a USB device address, a stream index, an endpoint address, bmattributes, and wMaxPacketSize. The USB device address refers to the physical address of a device, such as a MAC address. The endpoint address refers to the address of the part of a device that receives the transaction. The stream index refers to the unique number of a channel time allocated by the PNC in response to the request of the USB host. The bmattributes is a field that represents the attribute value of an endpoint in a USB endpoint descriptor shown in FIG. 9. The type of a transfer, such as a control transfer, an isochronous transfer, an interrupt transfer or a bulk transfer, is represented by the value of bmattributes. The wMaxPacketSize is a field that represents the maximum size of a packet that can be transferred and received by an endpoint.

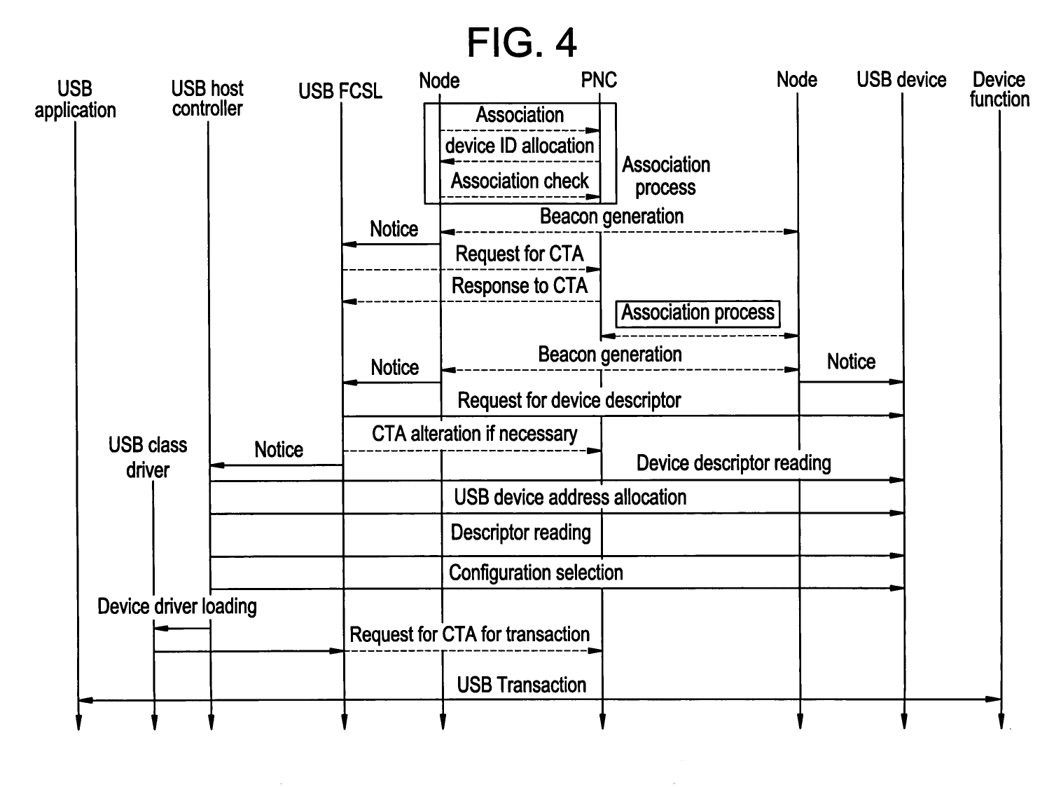

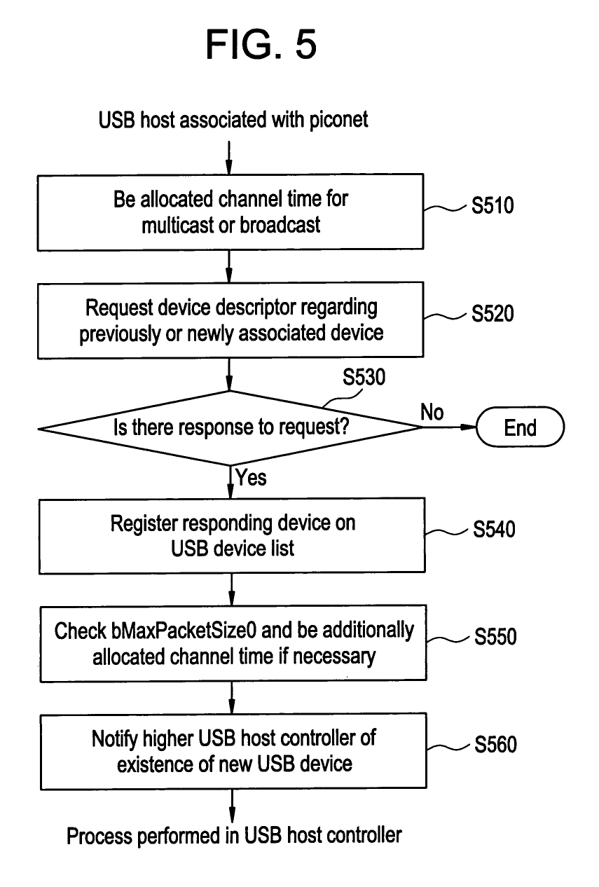

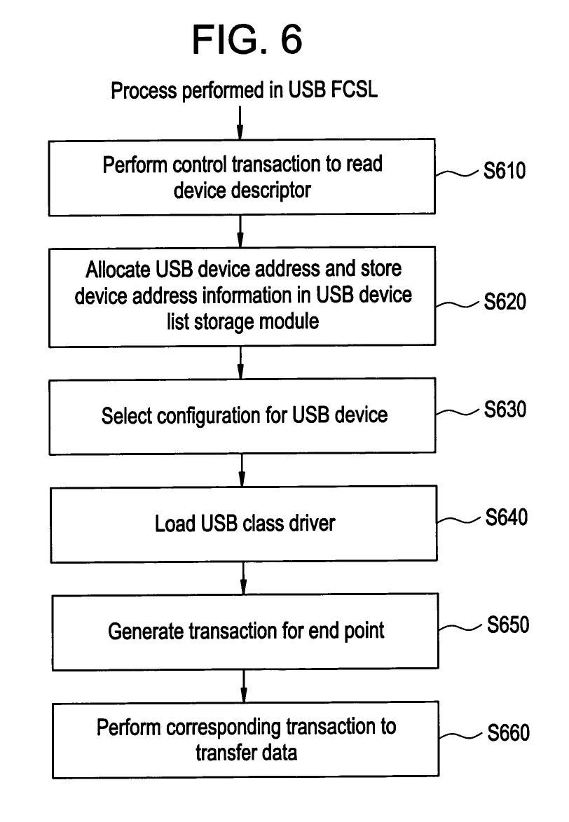

FIG. 4 is a diagram illustrating the entire procedure of wireless communication between the USB host and the USB device. The procedure is divided into a process performed in the USB FCSL of the USB host and a process performed in a layer higher than the USB FCSL, and is described based upon the two processes. The former process is described in detail with reference to FIG. 5, while the latter process is described in detail with reference to FIG. 6.

FIG. 5 is a flowchart showing a process of discovering a USB device.

When the USB host controller of the present invention is associated with the PNC, the USB host controller is allocated the channel time for multicast or broadcast to discover the USB device at step S510. This step is performed through the endpoint bandwidth allocation module (refer to 350 in FIG. 3). The USB host controller obtains the information of a previously associated device or newly associated device from the PNC, and requests a device descriptor from the device at step S520. If there is a response to the request, a corresponding node is registered on the USB device list at steps S530 and S540. In this case, bmattributes (refer to FIG. 9) may be checked and a channel time may be additionally allocated if necessary at step S550. The value of bmattributes is the maximum size of the packet for the endpoint, and can have 8, 16, 32 or 64 as a value. Thereafter, the higher USB host controller (refer to 240 in FIG. 3) is notified of the existence of the new USB device at step S560.

FIG. 6 is a flowchart showing the process performed in the layer higher than the USB FCSL.

The USB host layer reads a device descriptor by performing a control transaction so as to obtain information on a new device at step S610. In this case, each transaction packet is encapsulated into a MAC packet. At the time of such a control transaction, the address of a target device is a default address and channel time allocation for multicast or broadcast is utilized. Further, the MAC address of a device that is not allocated a USB device address is selected from a USB device list stored in the USB device list storage module (refers to 330 in FIG. 3), and is transferred to a higher layer through a MAC ISOCHronous DATA Service Access Point (MAC ISOCH DATA SAP).

Thereafter, a USB device address is allocated and the information of the allocated USB device address is stored in the USB device list storage module at step S620. A configuration is selected for the USB device at step S630. If an endpoint is determined by this selection, a transfer method and a required bandwidth corresponding to the endpoint are determined. This information is also stored in the USB device list storage module.

Thereafter, a corresponding USB class driver is loaded using information on the class, subclass, protocol and vendor ID of the device or interface descriptor at step S640. The required bandwidth of the transaction may be allocated at the time when the class driver is loaded as described above. However, in this embodiment, in order to efficiently utilize a wireless communication medium, the required bandwidth of the transaction is allocated when there is a request from an application.

In response to the request of the application, the class driver generates a transaction for a corresponding endpoint at step S650. This endpoint refers to a part of the device that receives a transaction. A plurality of endpoints may exist in a single device.

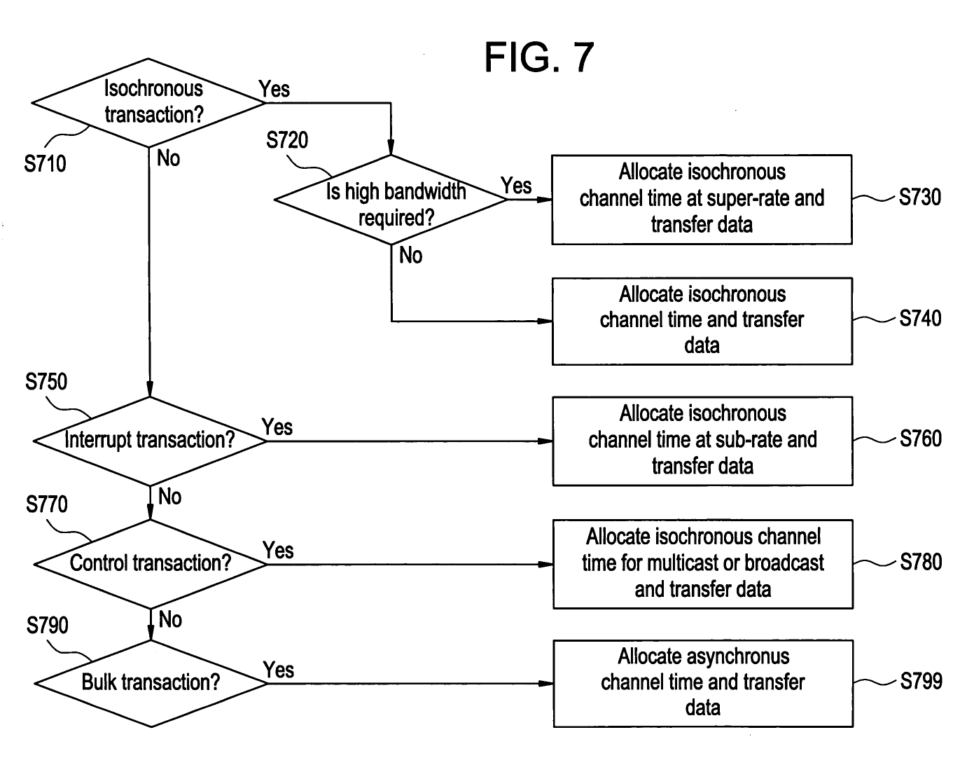

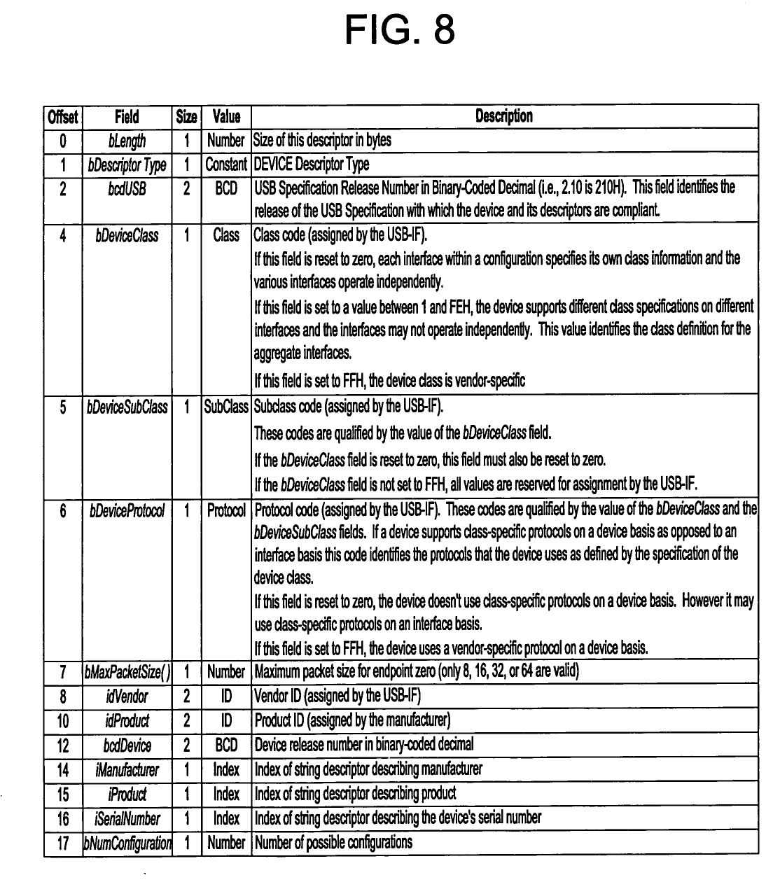

Such a transaction is transferred to the USB FCSL through the host controller. The USB FCSL examines the address of the target device and the address of the endpoint, reads the USB device list stored in the USB device list storage module (refer to 330 in FIG. 3), finds a MAC address and a corresponding Channel Time allocation (CTA), and transfers data for a corresponding channel time at step S660. The details of the step of transferring data are described in conjunction with FIG. 7.

Thereafter, a new USB device may be associated or previously associated device may be dissociated, which can be known through the MLME-DEV-ASSOCIATION of the MLME SAP. In the case of association, the discovery module (refer to 340 in FIG. 3) starts the discovery process. If dissociation occurs, the item of a corresponding device is removed from the USB device list and a higher layer is notified of the detachment of the device.

FIG. 7 is a flowchart showing the details of the step of allocating a channel time and transferring data. If the endpoint that can be known from the USB endpoint descriptor supports the control, isochronous and interrupt transactions, the initial value of the corresponding endpoint is set to ‘Unassigned StreamIndex.’ Since a channel time is not allocated yet, the channel time is allocated through the endpoint bandwidth allocation module from the PNC, and data are transferred through the MAC ISOCH DATA SAP. At this time, a No Ack policy is employed. In this case, the StreamIndex means the unique number of the channel time allocated from the PNC in response to the request of the USB host.

If a previously allocated StreamIndex exists in the USB device list, data are transmitted using a channel time corresponding to the previously allocated channel time. In the case of the bulk transaction, the value of the StreamIndex is always 0 because the bulk transaction uses asynchronous channel time allocation, and data are transmitted using MAC ASYNChronous DATA Service Access Point (MAC ASYNC DATA SAP).

With reference to FIG. 7, transmission methods are described for all transactions.

In the case of the isochronous transaction at step S710, the endpoint bandwidth allocation module (see 350 in FIG. 3) determines whether a high bandwidth is required at step S720. If the high bandwidth is required at step S720, an isochronous channel time is allocated at a super-rate, and data are transferred during a corresponding channel time at step S730. In this case, the super-rate can be determined through bit 12 and 11 of the wMaxPacketSize of FIG. 9. The allocation of the channel time at the super-rate is performed by the channel allocation method in which the channel times of a number corresponding to the super-rate are allocated in a single super frame and, therefore, a channel time periodically occurs between repeated super frames.

If the high bandwidth is not required at step 720, a general isochronous channel time is allocated, and data are transferred during a corresponding channel time at step S740. Accordingly, a single channel time is allocated in a single super frame, and the channel time periodically occurs between repeated super frames.

In the case of the interrupt transaction at step S750, an isochronous channel time is allocated at a sub-rate and data are transferred during a corresponding channel time at step S760. At this time, the sub-rate can perceive a sub-rate interval through the bInterval of FIG. 9. The allocation of a channel time at a sub-rate is performed by the channel allocation method in which after a channel time is allocated in a single super frame, the same channel time is repeatedly allocated after every super frames corresponding to a sub-rate interval.

In the case of the control transaction at step S770, an isochronous channel time for multicast or broadcast is allocated and data are transferred during a corresponding channel time at step S780.

In the case of the bulk transaction at step S790, an asynchronous channel time for multicast or broadcast is allocated and data are transferred during a corresponding channel time at step S799. The allocation of an asynchronous channel time is performed by the channel allocation method that has no periodic characteristics, differently from the channel allocation methods for the above-described transactions. In this method, if there is no available channel time in a Contention Free Period (CFP) that is a portion of a super frame to which a channel time is allocated, data has to wait for the next frame. In contrast, if there is an available channel time, the data are transferred using the channel time.

In accordance with the present invention, software and USB devices, which are widely used in existing wired communication networks and well defined, are allowed to be used in wireless PAN networks, the inconvenience of wired communication can be removed and an environment is provided to more easily develop wireless PAN application software.

Additionally, the present invention is compatible with existing wireless PAN application software that does not use USB devices. Further, the present invention includes a computer-readable recording medium for recording a computer program code for enabling a computer to provide the above method.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for transferring transactions of a Universal Serial Bus (USB) over a wireless Personal Area Network (PAN), comprising:
a USB device discovery module configured to discover a USB device from devices on the wireless PAN;
a USB device list storage module configured to store information of the discovered USB device; and
an endpoint bandwidth allocation module configured to allocate an appropriate channel time according to a type of a transaction determined from the information of the discovered device.

2. The apparatus as set forth in claim 1, further comprising:
an encapsulation module configured to encapsulate a USB packet into a Media Access Control (MAC) packet to transfer data to the discovered USB device; and
a decapsulation module configured to decapsulate a MAC packet received from the discovered USB device into a USB packet.

3. A wireless piconet system, further comprising:
a PicoNet Coordinator (PNC) receiving a request for a channel time allocation from a Universal Serial Bus (USB) host and to allocate an appropriate channel time; and
a USB host configured to discover a USB device from devices on a wireless Personal Area Network (PAN) and to be allocated the appropriate channel time according to a type of a transaction, which can be found from an information of the discovered device, from the PAN; wherein the USB device transfers/receives data to/from the USB host according to the type of the transaction during the allocated appropriate channel time.

4. A method of transferring transactions of a Universal Serial Bus (USB) over a wireless Personal Area Network (PAN), comprising the steps of:
reading a device descriptor of an associated USB device;
ascertaining a type of a transaction of an endpoint using the device descriptor; and
determining a channel time according to results of the ascertaining and transferring data during the channel time.

5. The method as set forth in claim 4, further comprising the step of discovering the associated USB device before the step of reading the device descriptor.

6. The method as set forth in claim 5, wherein the step of discovering the associated USB device comprises:
allocating the channel time for multicast or broadcast from a PicoNet Coordinator (PNC);
requesting the device descriptor from a previously associated or a newly associated USB device;
registering the one of the previously associated or the newly associated USB device responding to the request on a USB device list; and
notifying a higher USB host controller of an existence of the newly associated USB device.

7. The method as set forth in claim 4, further comprising the step of examining a maximum size of a packet for an endpoint using the device descriptor and allocating an additional channel time if necessary.

8. The method as set forth in claim 4, further comprising the following steps between the steps of reading the device descriptor and ascertaining a type of a transaction:
loading a corresponding associated USB class driver using information of the device descriptor;
allocating an address of the USB device and storing information of the allocated address in a USB device list storage module; and
selecting a configuration for the associated USB device.

9. The method as set forth in claim 8, further comprising the step of generating by a class driver a transaction for a corresponding endpoint in response to a request of an application after the step of the loading the USB class driver.

10. The method as set forth in claim 4, further comprising, if the endpoint supports an isochronous transaction: allocating an isochronous channel time at a super-rate and transferring the data during a corresponding channel time if a high bandwidth is required; and allocating a general isochronous channel time and transferring the data during a corresponding channel time if the high bandwidth is not required.

11. The method as set forth in claim 4, wherein, if the endpoint supports an interrupt transaction, an isochronous channel time is allocated at a sub-rate and data are transferred during a corresponding channel time.

12. The method as set forth in claim 4, wherein, if the endpoint supports a control transaction, an isochronous channel time for multicast or broadcast is allocated and data are transferred during a corresponding channel time.

13. The method as set forth in claim 4, wherein, if the endpoint supports a bulk transaction, an asynchronous channel time is allocated and data are transferred during a corresponding channel time.

14. A computer-readable recording medium for recording a computer program code for enabling a computer to provide a service of transferring transactions of a Universal Serial Bus (USB) over a wireless Personal Area Network (PAN), the service comprising the steps of:
reading a device descriptor of an associated USB device;
ascertaining a type of a transaction of an endpoint using the device descriptor; and
determining a channel time according to results of the ascertaining and transferring data during the channel time.
